(19) United States
(12) Patent Application Publication
(10) Pub. No.: US 2025/0367618 A1
(43) Pub. Date: Dec. 4, 2025

(54) Multilingual Visualizer AI Coaching Trainer and Control Module with Universal Display Adaptation. Real-time Additive Management and Cross-Industry Compatibility

(71) Applicant: Walid A. EI Khechen, Phoenix, AZ (US)

(72) Inventor: Walid A. EI Khechen, Phoenix, AZ (US)

(73) Assignee: Noble Rise TR, Phoenix, AZ (US)

(21) Appl. No.: 19/303,384

(22) Filed: Aug. 19, 2025

(51) Int. Cl. B01F 33/84; B01F 101/30; G05B 13/02; G06F 21/31

(52) U.S. Cl. CPC B01F 33/8442; G05B 13/0265; G06F 21/31; B01F 2101/30

(57) ABSTRACT

An AI-driven coating training and control system configured to manage additives and pigments across resin formulations including epoxy, polyester, urethane, UV-curable, and hybrids. The system comprises a secure additive dosing module and modular interface capable of connecting to third-party pigment mixing banks. An AI logic engine calculates ratios, generates deployment profiles, and integrates environmental and substrate data. The system further enables visual simulation of projected finishes and provides multilingual operator interfaces including speech and sign language. When a desired color cannot be formulated locally, the AI queries pigment libraries to identify alternatives, ensuring universal color matching across industries. Authentication protocols, encrypted updates, and cartridge validation prevent unauthorized use. Applications include automotive, aerospace, marine, and industrial coatings, with learning-loop optimization for improved finish consistency and security.

### CROSS-REFERENCE TO RELATED APPLICATIONS

This application claims the benefit of priority under 35 U.S.C. § 119 (e) to the following U.S. Provisional Patent Applications, the entire disclosures of which are incorporated herein by reference in their entireties:

U.S. Provisional Patent Application No. 63/857,457, filed Aug. 4, 2025, entitled “DripReaper™ Coating System with AI-Driven Pigment Modulation and Terrain-Adaptive Overlays.”

U.S. Provisional Patent Application No. 63/860,861, filed Aug. 9, 2025, entitled “GlenDyzer™ Modular Polyester Resin Conversion System for Sprayable and Castable Coatings.”

U.S. Provisional Patent Application No. 63/861,307, filed Aug. 11, 2025, entitled “UV-Curable and Dual-Cure Resin-Based Coating Systems with Modular AI-Integrated Pigment and Additive Delivery for Epoxy and Polyester Applications.”

U.S. Provisional Patent Application No. 63/862,230, filed Aug. 12, 2025, entitled “OEM-Integrated AI Platform with Human-Machine Mediation for Pigment Formulation, Visualization, and Adaptive Deployment Across Resin and Coating Systems.”

U.S. Provisional Patent Application No. 63/864,186, filed Aug. 14, 2025, entitled “Integrated Resin Additive Deployment System with Logic-Controlled Optimization and Multi-Substrate Performance Modifiers.”

U.S. Provisional Patent Application No. 63/865,942, filed Aug. 15, 2025, entitled “Sign Language-Enabled Mode within Multilingual AI Coating Trainer and Control Module with Universal Display Compatibility, Real-Time Adaptive Guidance, and Integrated/Standalone Operation.”

### FIELD OF THE INVENTION

The present invention relates to resin-based coating systems, AI-guided application platforms, pigment and additive management systems, and universal visual training modules. Specifically, it concerns a centralized AI command system that controls, optimizes, and adapts every aspect of coating operations-including pigment selection, metallic and pearl modulation, additive dosing, and global pigment sourcing beyond local mixing banks. The system functions as an intermediary between human operators and software platforms, continuously generating evolving custom color bases through adaptive learning.

In addition, the invention integrates a multilingual and sign-language-enabled visual coaching interface that provides real-time training, outcome visualization, and cross-platform compatibility across smartphones, headsets, projectors, wearables, and future display devices. The system is designed for civilian, industrial, and tactical applications, enabling both universal accessibility and mission-specific adaptability.

### BACKGROUND OF THE INVENTION

### 1. Current Challenges

Coating operations worldwide face serious and persistent limitations:

Communication Barriers: Trainers and operators struggle with language differences, and verbal instructions fail in high-noise or hazardous environments such as shipyards, refineries, aerospace hangars, and combat zones.

Accessibility Gaps: Deaf or hard-of-hearing professionals lack effective training solutions.

Fragmentation: Existing training platforms cannot adapt across multiple resin chemistries or environments.

Inefficiency in Materials: Additive dosing and pigment selection remain error-prone, causing cost overruns, waste, and inconsistent quality.

### 2. Gaps in Existing Solutions

While some AI-based coating or mixing software tools exist, none combine the following critical features into a single system:

Universal Language Adaptability: Spoken, written, and sign language integration.

Direct Additive and Pigment Control: Real-time dosing tied to proprietary resin conversion systems.

Cross-Industry Resin Compatibility: Epoxy, polyester, urethane, ceramic, silicone, nano, and emerging chemistries.

Silent & Tactical Deployment: Military-grade guidance without verbal instruction for covert or hazardous settings.

Universal Display Integration: Compatibility with monitors, AR/VR, holographics, projectors, wearables, and future display platforms.

### 3. Advantages Over Prior Art

The present invention provides significant advantages over prior art coating systems and pigment mixing technologies. Conventional coating dispensers and pigment banks require manual selection, manual dosing, or preprogrammed formulas, which limit flexibility, accuracy, and adaptability. Existing systems also fail to provide real-time multilingual operator guidance, cross-platform adaptability, or secure enforcement of additive usage.

Unlike prior systems, the disclosed AI-driven control module eliminates manual trial-and-error by automatically calculating pigment and additive ratios based on substrate, environment, and user-defined targets. All pigment and additive deployments are authorized and executed by the AI logic engine, ensuring consistent outcomes, preventing counterfeit material substitution, and protecting proprietary additive libraries.

A further advantage is the modular AI mixing bank interface, which enables direct connection to OEM or third-party dispensing machines without hardware modification. This allows universal bridging across multiple platforms, maximizing compatibility and protecting against obsolescence.

The invention additionally supports a global pigment library, allowing the AI to identify and source compatible pigments worldwide, even when local mixing banks cannot meet target specifications. This creates a universal color-matching and sourcing capability, providing unmatched flexibility for civilian, industrial, and tactical applications.

Moreover, the system incorporates visualization and simulation modules that preview results in real time, adaptive learning loops that refine outcomes based on operator feedback, and secure cloud-based authentication to enforce compliance. Collectively, these features create a complete ecosystem that addresses the critical shortcomings of prior art by delivering precision, adaptability, interoperability, and security.

### 4. Best Mode for Carrying Out the Invention

The best mode presently contemplated for carrying out the invention is an AI-controlled coating system deployed with the GlenDyzer™ polyester resin conversion system and DripReaper™ epoxy resin conversion system, paired with a multilingual visualizer module capable of rendering real-time coating simulations in spoken, written, and sign language formats.

In its preferred configuration, the system operates with an AR headset or touchscreen tablet running the AI logic engine, networked to an additive dosing control module equipped with RFID-tagged additive cartridges. Civilian and tactical additive libraries are stored in separate encrypted profiles. The AI logic engine receives environmental inputs from onboard or external sensors and generates adaptive deployment profiles comprising pigment ratios, additive selection, curing times, and substrate adjustments. The additive dosing control module dispenses the precise ratios calculated by the AI, while the visualizer module coaches the operator in their preferred language or communication mode, adapting feedback in real time. This configuration delivers optimal efficiency, accuracy, and repeatability while preventing unauthorized operation or substitution of unapproved additives.

### SUMMARY OF THE INVENTION

The invention delivers a Multilingual Visualizer AI Trainer & Control Module that:
1. Acts as a universal AI coach-delivering instructions in any spoken, written, or sign language to guide operators in coating deployment.
2. Directly controls additive dosing for DripReaper™ (epoxy) and GlenDyzer™ (polyester) resin conversion systems, as well as any compatible resin chemistry.
3. Functions as a central intermediary between the operator and any mixing system—including proprietary and third-party pigment banks—by authorizing and executing all pigment and additive operations through its AI logic engine. The module continually expands its database through global pigment sourcing and operator feedback, generating a personalized, ever-learning user experience.
4. Operates with existing hardware-including tablets, AR/VR headsets, holographic projectors, and future display devices-without requiring proprietary manufacturing of the display hardware.
5. Adapts in real time using environmental and application data from integrated sensors, automatically adjusting pigment ratios, additive deployment, curing times, and substrate parameters.
6. Supports both tactical/military and civilian industries, enabling silent communications in operations where stealth is critical.
7. Functions as a standalone training module or integrates into automated mixing banks and resin deployment systems, bridging across civilian, industrial, and tactical use cases.
8. Learns from global input, merging formal industry standards with real-world feedback to optimize pigment sourcing, additive packs, and application methods.

### BRIEF DESCRIPTION OF THE DRAWINGS

FIG. 1—System overview diagram showing the AI module functioning as a central intermediary between operator, pigment/additive libraries, and resin system integration.

FIG. 2—Multilingual visualization output across multiple display platforms (AR/VR headsets, tablets, projectors, wearables).

FIG. 3—Sign language output interface for noisy industrial and tactical environments.

FIG. 4—Additive dosing control interface adaptable to multiple resin chemistries, with AI-enforced authorization of cartridges.

FIG. 5—Civilian/industrial deployment scenario highlighting pigment selection, vendor recommendation, and additive optimization.

FIG. 6—Tactical/military stealth scenario showing AI-driven pigment sourcing and adaptive additive ratios for signature reduction.

FIG. 7—AI adaptive learning loop that refines operator skill and generates a personalized pigment/additive database.

FIG. 8—Modular AI mixing bank integration, enabling compatibility with OEM and third-party pigment systems without hardware modification.

### DETAILED DESCRIPTION OF THE INVENTION

The term “universal display compatibility” refers to the system's ability to interface with a wide range of visual output devices using standardized communication protocols such as HDMI, USB-C, Bluetooth, Wi-Fi, and future wireless or optical interfaces. The system adapts its output resolution, aspect ratio, and rendering format to match the specifications of the connected display, whether fixed or wearable. This includes smartphones, tablets, televisions, wall-mounted monitors, AR/VR headsets, holographic projectors, heads-up displays (HUDs), and emerging visual mediums. No proprietary hardware is required, and the system maintains software-based adaptability to evolving display standards, ensuring seamless integration with both current and future technologies.

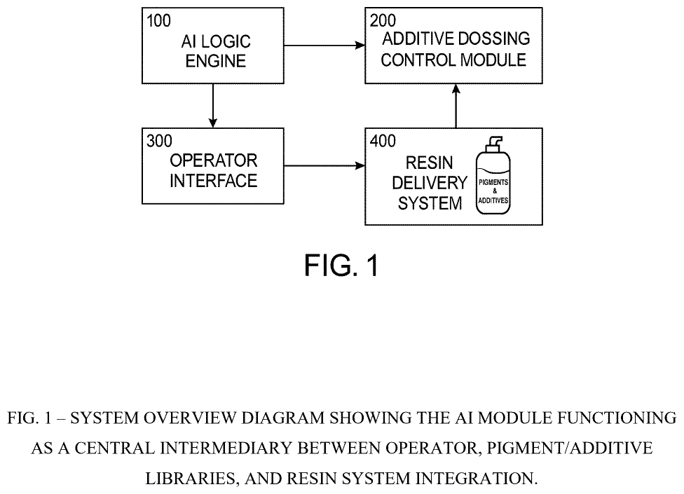

The system includes a modular visual simulation engine that dynamically generates instructional overlays, gesture animations, and coating process visualizations based on user context and selected deployment mode. As shown in FIG. 1, the system integrates an AI logic engine (100), additive dosing control module (200), operator interface (300), and resin delivery system (400) into a unified operational platform. Simulations are rendered in real time using scalable vector formats and adaptive resolution logic, ensuring clarity across devices ranging from smartphones to large-format displays. The engine supports multilingual text prompts, region-specific gesture sets, and coating-specific visual cues, enabling tailored instruction for diverse user profiles. Visual outputs are validated through scenario-based testing to ensure legibility, timing accuracy, and instructional effectiveness across display environments.

The system includes accessibility-focused modules designed to support users with hearing, speech, or language-related challenges. These modules enable sign language input recognition via camera-based gesture tracking and provide multilingual visual prompts rendered in customizable formats. The system is compatible with assistive technologies such as screen readers, voice output devices, and alternative input controllers. Accessibility features are software-driven and do not require proprietary hardware, ensuring deployment across standard smartphones, tablets, and display systems. In preferred embodiments, the system automatically adapts its instructional flow based on detected user preferences or accessibility profiles.

The system supports integration with multiple coating deployment methods, including HVLP spray guns, robotic arms, aerosol dispensers, and UV-curable systems. Instructional overlays and control prompts are dynamically adapted based on the selected method, with real-time adjustments to gesture guidance, timing cues, and safety alerts. The system's modular architecture enables seamless switching between deployment modes without requiring hardware reconfiguration. In preferred embodiments, deployment-specific modules are activated via user selection or automated detection, ensuring accurate instruction and optimized coating outcomes across diverse environments.

The system is designed for modular licensing and integration across OEM platforms, third-party hardware, and software ecosystems. Licensing control is enforced through software-based mechanisms, including but not limited to activation keys, usage tracking modules, and deployment-specific configuration files. These mechanisms enable selective enablement of features based on licensing tier, geographic region, or deployment method. The system architecture supports remote updates and license audits, ensuring compliance and facilitating scalable monetization across sectors. No proprietary hardware is required, and licensing enforcement is fully software-driven.

The system has been validated through scenario-based testing across multiple deployment environments, user profiles, and accessibility configurations. Validation scenarios include multilingual instruction delivery, sign language input recognition under varied lighting conditions, coating guidance for HVLP and robotic systems, and visual prompt legibility across smartphones, tablets, and large-format displays. Each scenario is designed to assess instructional clarity, timing accuracy, gesture responsiveness, and user comprehension. Results confirm consistent performance across diverse conditions, supporting reliable deployment in OEM, training, and accessibility-focused applications.

### Civilian and Industrial Application Mode

In civilian and industrial settings, the module acts as:

A multilingual trainer for coating professionals across sectors such as automotive, marine, aerospace, architecture, and industrial manufacturing.

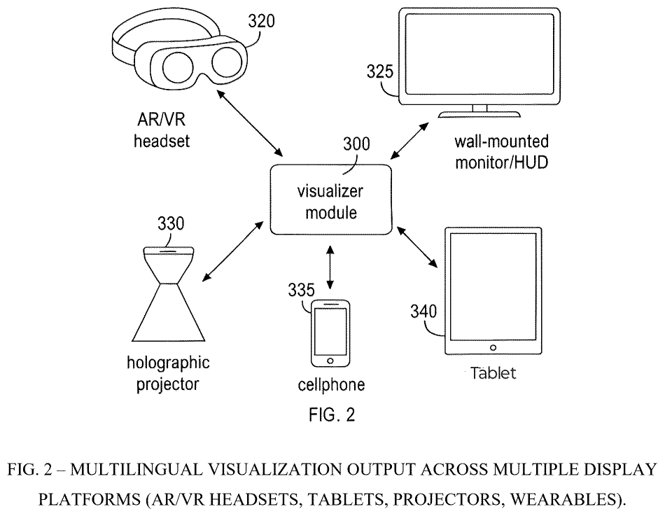

In FIG. 2, the visualizer module outputs real-time instructions across multiple display platforms, including tablets (340), AR/VR headsets (320), holographic projectors (330), and wall-mounted or heads-up displays (325).

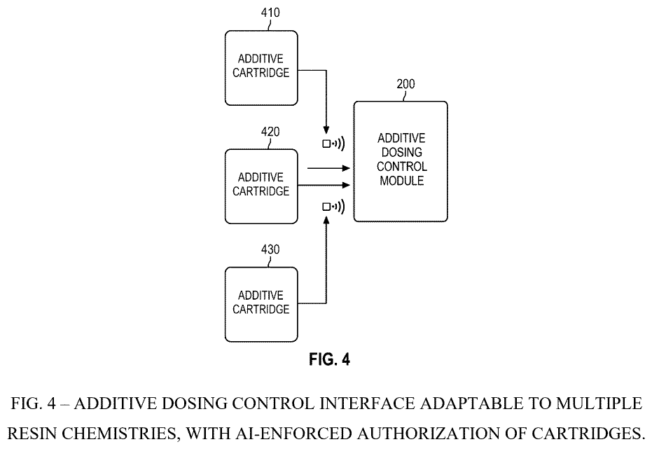

As illustrated in FIG. 4, the additive dosing control module (200) manages three discrete additive cartridges: cartridge A (410), cartridge B (420), and cartridge C (430). Each cartridge is authenticated via RFID or digital signature protocols to prevent unauthorized additive use. The module enables real-time adjustment of pigment load, matting agents, flow modifiers, and specialty functional additives. This configuration supports secure additive management and optimized dosing across deployment environments. In preferred embodiments, the dosing module interfaces with upstream logic and operator controls to ensure precise additive selection and deployment.

An additive management system capable of adjusting pigment load, matting agents, flow modifiers, and specialty functional additives in real time.

A process optimizer that monitors environmental variables-temperature, humidity, surface reflectivity—to adjust application parameters.

A compatibility layer for resin chemistries beyond DripReaper™ and GlenDyzer™, ensuring lock-in across the entire topcoat market.

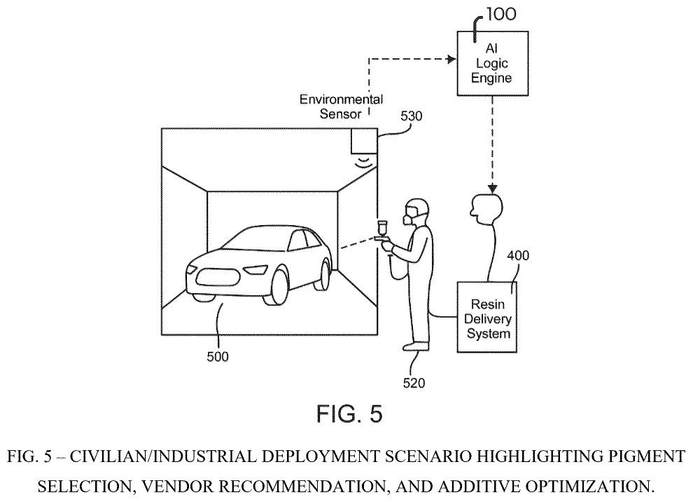

As shown in FIG. 5, the system includes an additive and pigment management platform configured to integrate load-adjusting agents, flow and release modifiers, and environmental process control variables such as temperature, humidity, and pressure. These inputs are received and processed by the AI logic engine 100, which dynamically modulates resin delivery via system 400. The platform supports both static deployment (e.g., compact pick-up configurations) and mobile field applications, including tactical operations. Environmental sensor 530 continuously monitors booth conditions, enabling real-time adjustments to deployment parameters. Manual or robotic deployment module 520 interfaces with the resin delivery system to apply pigment and additive formulations onto target substrates such as car 500 within a spray booth environment. The system may be configured for epoxy-based deployment via DripReaper™ or polyester-based deployment via GlenDyzer™, with each conversion pathway optimized for substrate compatibility, curing profile, and additive integration.

### Tactical and Military Application Mode

For tactical/military use, the module:

Provides silent operational guidance via sign language output, holographic overlays, or written instructions, ensuring communication in high-noise or stealth-critical environments.

Automatically selects and doses infrared signature reduction additives, radar cross-section (RCS) modifiers, and terrain-adaptive pigments.

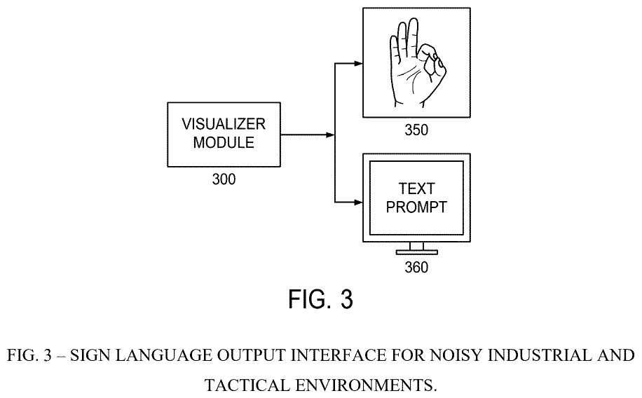

As depicted in FIG. 3, the system includes a visualizer module (300) that renders silent instructional overlays via the text prompt module (350) and deployment module (360). These components work in tandem to deliver sign language output, holographic visual cues, and written instructions in high-noise or stealth-critical environments. The visualizer module (300) receives gesture input from the operator and dynamically adjusts the instructional flow based on mission parameters. The text prompt module (350) supports multilingual written guidance, while the deployment module (360) manages output formatting across AR/VR headsets, holographic projectors, and heads-up displays. This configuration enables silent, adaptive communication without reliance on audio output, ensuring operational effectiveness in stealth-critical or acoustically challenging environments.

Supports stealth deployment by operating in complete silence while relaying mission-specific coating instructions.

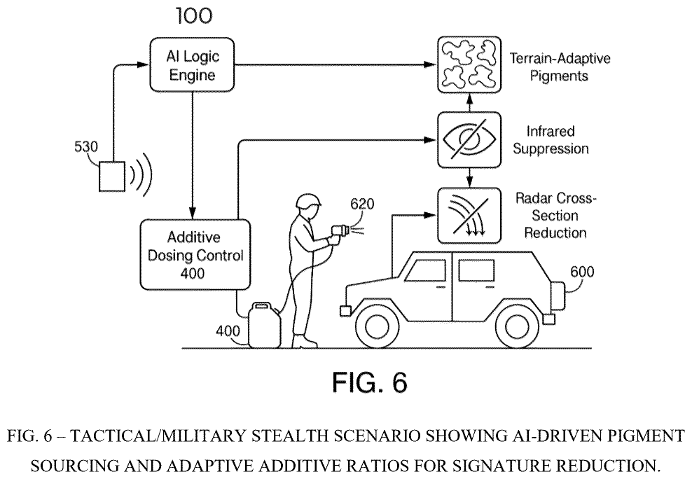

As shown in FIG. 6, tactical deployment includes AI-driven selection of terrain-adaptive pigments, infrared signature reduction agents, and radar cross-section modifiers for mission-specific coatings.

Enables rapid adaptation to changing theater environments—desert, arctic, urban, jungle—through instant pigment formula recalibration.

In Tactical and Military Application Mode, vehicle 600 receives a multi-layered coating system comprising terrain-adaptive pigment, infrared suppression, and radar cross-section reduction. These treatments are governed by AI logic engine 100, which receives environmental input from sensor 530 and modulates additive dosing via control system 400. Operator interface 620 enables manual override, scenario selection, and real-time feedback, supporting encrypted deployment and adaptive concealment across mission-specific environments.

### Real-Time Coaching and Adaptive Learning

The Visualizer is not a static training program—it is a live, AI-driven coach that: Observes operator performance via vision sensors (or manual input).

Modifies instructional style based on operator skill, pace, and error patterns.

Creates 1:1 customized training pathways instead of one-size-fits-all modules.

Learns and evolves from global operator feedback, continuously improving instructions, dosing models, and additive combinations.

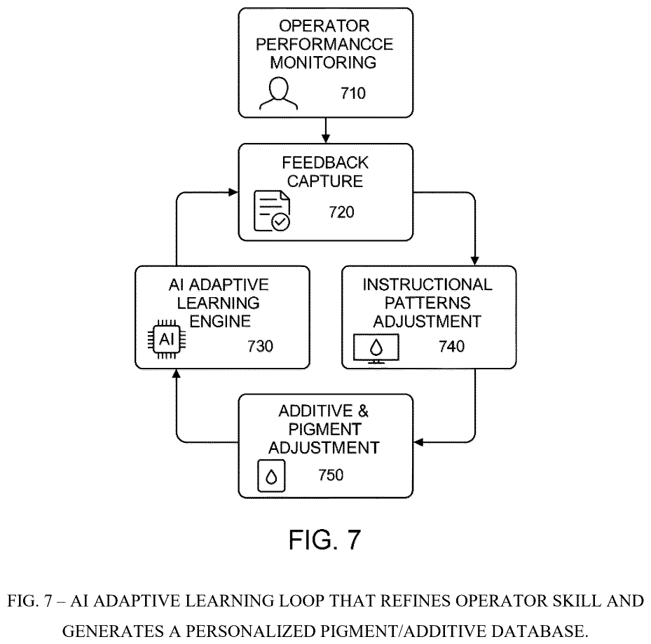

As illustrated in FIG. 7, operator performance monitoring data 710 is fed into the AI adaptive learning loop, where feedback informs future instructional adjustments, pigment ratios, and additive selections.

Instructional patterns adjustment module 740 may be configured to modify the delivery, timing, or modality of operator instructions based on performance trends, learning velocity, or scenario-specific requirements. Additive and dynamic adjustment module 750 may be provided to alter coating composition, deployment parameters, or instructional overlays in real time. Module 750 may respond to outputs from the AI adaptive learning engine 730 and feedback capture module 720, enabling scenario-specific modulation of visual, tactile, or chemical cues to enhance operator performance, accessibility, and training outcomes.

### Hardware Compatibility and Non-Ownership Clause

The invention does not claim ownership of hardware such as tablets, AR/VR headsets, projectors, or holographic displays. Instead, it leverages existing and future devices, ensuring that the platform:

Is future-proof against emerging display technologies.

Avoids dependency on any single hardware supplier.

Maintains software-based compatibility with an evolving technology landscape.

### Pigment Integration and Global Sourcing

The interface can connect to any third-party pigment mixing bank.

The AI logic can query worldwide pigment libraries or OEM databases.

If the local bank cannot reproduce a requested color, the AI suggests alternate formulations from global supply chains.

This dual capability (additive+pigment) ensures universal compatibility and maximizes protection.

This reinforces that pigments are fully within the system's scope, not just additives.

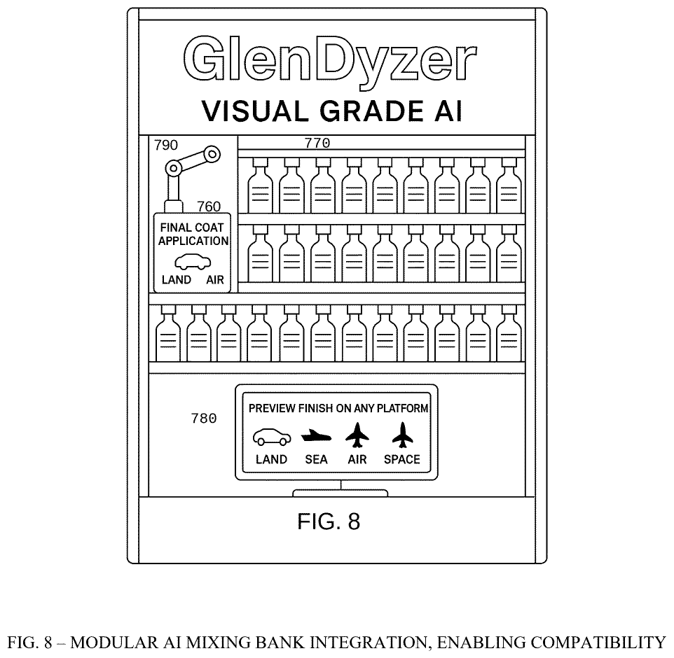

FIG. 8 illustrates the modular AI-controlled pigment and additive mixing bank integration, comprising surface selector 760, additive and pigment bank 770, visual preview engine 780, and deployment module 790. The interface bridges third-party mixing systems with the AI logic engine, enabling real-time querying of global pigment libraries and OEM databases. If a local bank cannot reproduce a requested color, the AI suggests alternate formulations based on substrate type, environmental conditions, and licensing constraints. The preview engine 780 renders finish simulations across universal display formats, while the deployment module 790 enforces non-ownership overlays and accessibility toggles for inclusive execution.

1. A multilingual coating training and control system comprising: an AI logic engine; a pigment and additive dosing control module configured to receive dispensing commands exclusively from the AI logic engine, wherein said module functions in physical, virtual, hybrid, or hardware-assisted implementations; an interface configured to interpose between the AI logic engine and a coating mixing system, whether through an adapter, direct integration, or equivalent connection; a multilingual operator interface including spoken language, written text, and sign language modes, and a visualization output configured to display predicted coating outcomes, operator guidance, and real-time feedback across computing devices, and further configured to provide simulation and training modes and closed-loop adjustment during live coating application; and wherein the AI logic engine automatically computes pigment and additive ratios and manages mode selection for a target coating, validates compatibility with resin type, accesses pigment/additive data stored locally, remotely, or in distributed cloud databases, refines deployment profiles based on operator input, environmental sensing, or stored performance data, and transmits commands exclusively through the interface.

2. The system of claim 1, wherein said dosing control module includes an authentication mechanism selected from: electronic keying, RFID tagging, mechanical interlock, digital verification protocol, or chemical encoding, preventing activation without verified AI instruction.

3. The system of claim 1, wherein pigment and additive cartridges are rendered non-functional with non-authenticated systems via physical shaping, digital tagging, or cryptographic encoding.

4. The system of claim 1, wherein the AI logic engine integrates environmental and substrate data including humidity, ambient temperature, substrate color, gloss targets, and reflectivity requirements.

5. The system of claim 1, wherein operator authentication is required prior to system activation via biometric scan, PIN code, or secure hardware token.

6. The system of claim 1, wherein the AI logic engine generates adaptive deployment profiles comprising one or more of: pigment ratios, additive type selection, curing cycle time, substrate type, and environmental adjustment parameters.

7. The system of claim 6, wherein said adaptive deployment profiles further include mission-specific requirements selected from: camouflage patterning, infrared signature reduction, radar cross-section modulation, OSHA compliance parameters, or aesthetic customization.

8. The system of claim 1, wherein the adapter interface translates AI commands into control signals compatible with OEM or third-party mixing banks.

9. The system of claim 1, wherein the AI logic engine accesses pigment inventories stored locally within a mixing bank and remotely across globally distributed pigment databases.

10. The system of claim 9, wherein when a target color cannot be produced solely from pigments available in the connected mixing bank, the AI logic engine queries global pigment databases to identify compatible pigments or suppliers.

11. The system of claim 10, wherein the AI logic engine validates pigment compatibility with epoxy, polyester, urethane, UV-curable, and hybrid resin formulations prior to authorizing mixing.

12. The system of claim 1, further comprising a visual stimulation module configured to display projected coating results prior to live application, wherein said simulation includes rendering in multiple lighting and environmental conditions across visible, infrared, ultraviolet, and mixed spectrums, and further allows dynamic user adjustments to gloss, texture, and color blending.

13. The system of claim 1, wherein the dosing control module measures, mixes, and dispenses pigments and additives in ratios calculated in real time by the AI logic engine.

14. The system of claim 1, wherein additives include but are not limited to: gloss control agents, matting agents, stealth IR/RCS modulators, anti-fouling agents, slip-reduction agents, wet gloss enhancers, metallic pigments, pearls, and UV stabilizers.

15. The system of claim 1, wherein pigment and additive cartridges are encrypted, shaped, or digitally authenticated to prevent substitution with third-party materials.

16. The system of claim 1, wherein civilian and tactical additive/pigment libraries are stored in separate encrypted profiles within the AI logic engine.

17. The system of claim 1, wherein all dosing operations are logged for traceability, compliance, and licensing enforcement.

18. The system of claim 1, wherein all AI logic and pigment/additive library updates are delivered via encrypted cloud connection.

19. The system of claim 18, wherein the system prevents operation if unauthorized firmware or library data is detected.

20. The system of claim 1, wherein the AI logic Engine authenticates pigment and additive cartridges via secure cloud validation and enforces licensing through unique digital keys, and wherein said cloud service distributes software updates to the dosing and simulation modules and denies operation of unauthorized or counterfeit cartridges.

21. The system of claim 1, wherein the system is configured for one or more application domain selected from automotive refinishing, aerospace coatings, marine protective coatings, industrial surface treatments, and tactical or defense-oriented coatings.

22. The system of claim 1, wherein the AI logic engine incorporates an adaptive learning loop that captures operator feedback via manual input, performance metrics from finish quality scans, and sensor-based error detection, wherein said feedback modifies future instructional patterns, pigment/additive ratios, and deployment profiles, and wherein said adaptive learning loop stores operator performance profiles and applies them to subsequent coating projects to optimize efficiency and finish quality.
